(19) United States
(12) Patent Application Publication
(10) Pub. No.: US 2026/0266418 A1
(43) Pub. Date: Sep. 10, 2026

(54) FOLDING ULTRATHIN MOBILE PHONE SUPPORT

(71) Applicant: Zhongshan Wuxin Technology Co., Ltd., Zhongshan (CN)

(72) Inventor: Zongsheng XIN, Wuzhou (CN)

(73) Assignee: Zhongshan Wuxin Technology Co., Ltd., Zhongshan (CN)

(21) Appl. No.: 19/093,296

(22) Filed: Mar. 28, 2025

(30) Foreign Application Priority Data
Mar. 6, 2025 (CN) 2025203894921

(51) Int. Cl. F16M 11/38; F16M 11/04; F16M 11/24

(52) U.S. Cl. CPC F16M 11/38; F16M 11/041; F16M 11/242

(57) ABSTRACT

The present invention discloses a folding ultrathin mobile phone support, including a fixed member and a plurality of supporting legs rotatably connected to the fixed member, where the fixed member is provided with a storage groove, the supporting legs can be folded into the storage groove by rotation, and the supporting legs located in the storage groove can be unfolded by rotation to form a support. As a result, a thickness of the whole mobile phone support after being folded can be equal to a thickness of the fixed member, rather than a thickness of the stack of the fixed member and the supporting leg, and therefore, an ultrathin effect can be achieved, which not only occupies a small space, but also is more convenient to carry, thereby satisfying a higher requirement of a user.

### CROSS-REFERENCE TO RELATED APPLICATIONS

The application claims priority to Chinese patent application No. 2025203894921, filed on Mar. 6, 2025, the entire contents of which are incorporated herein by reference.

### TECHNICAL FIELD

The present invention relates to a tool for fixing and supporting a mobile phone, and in particular, to a folding ultrathin mobile phone support.

### BACKGROUND

With the development of society, mobile phones and other electronic devices have become a necessity in people’s life, and watching videos and reading articles through mobile phones has become a common way for people to read.

However, in the above manner, the mobile phone needs to be held by one hand all the time, and the hand holding the mobile phone for a long time is prone to fatigue, and therefore, a tool such as a mobile phone support (CN202420412712-FOLDING ULTRATHIN MOBILE PHONE SUPPORT) has appeared on the market at present. The mobile phone is supported and fixed through the mobile phone support, so that hands of a user are freed, and the use comfort is improved. In addition, in order to facilitate carrying, the mobile phone support is provided with a folding function. However, the mobile phone support with the structure is not thin enough after being folded, and the occupied space is relatively large.

Therefore, the applicant designs a thinner mobile phone support after being folded, which not only occupies a small space, but also is more convenient to carry, thereby satisfying a higher requirement of the user.

### SUMMARY

To overcome the deficiencies of the prior art, the present invention provides a folding ultrathin mobile phone support.

A technical solution used by the present invention to resolve the technical problem is:

a folding ultrathin mobile phone support, including a fixed member and a plurality of supporting legs rotatably connected to the fixed member, where the fixed member is provided with a storage groove, the supporting legs can be folded into the storage groove by rotation, and the supporting legs located in the storage groove can be unfolded by rotation to form a support.

The folding ultrathin mobile phone support further includes a connecting member rotatably connected to the fixed member, where the supporting legs are all rotatably connected to the connecting member, and the connecting member can be folded into the storage groove by rotation.

The fixed member comprises an annular body and two rod bodies, a space between the rod bodies forms the storage groove, and the connecting member is located between the two rod bodies.

The connecting member is rotatably connected to the rod body through a connecting shaft.

The plurality of supporting legs include a first supporting leg and second supporting legs oppositely arranged on the connecting member, and the first supporting leg and the two second supporting legs form a triangle with a supporting point in contact with a supporting surface after being unfolded.

The first supporting leg is rotatably connected to the connecting member through a first rotating shaft, and the second supporting legs are both rotatably connected to the connecting member through a second rotating shaft.

The two second rotating shafts are arranged in parallel, and the first rotating shaft is arranged perpendicular to the second rotating shaft.

The connecting member is provided with a first connecting plate, the second supporting leg is provided with a second connecting plate, the first connecting plate is provided with a connecting through hole, the second rotating shaft is located on the second connecting plate and inserted into the connecting through hole, the second connecting plate is provided with a connecting screw hole penetrating through the second rotating shaft, the second rotating shaft is a screw, the screw is matched with the connecting screw hole through the connecting through hole, the second connecting plate is provided with a limiting groove, and the first connecting plate is provided with a limiting block located in the limiting groove.

A magnet is arranged in the fixed member.

A groove is formed in the connecting member, an end portion of the first supporting leg is located in the groove, the connecting shaft is a pin shaft, and the connecting member and the first supporting leg are each provided with a pin hole matched with the pin shaft.

The present invention has the following beneficial effects: in the present invention, the fixed member is provided with a storage groove, the supporting legs can be folded into the storage groove by rotation, and the supporting legs located in the storage groove can be unfolded by rotation to form a support. As a result, a thickness of the whole mobile phone support after being folded can be equal to a thickness of the fixed member, rather than a thickness of the stack of the fixed member and the supporting leg, and therefore, an ultrathin effect can be achieved, which not only occupies a small space, but also is more convenient to carry, thereby satisfying a higher requirement of a user.

### BRIEF DESCRIPTION OF THE DRAWINGS

The following describes the present invention in more detail with reference to the accompanying drawings and embodiments.

FIG. 1 is a view of a mobile phone support fixed with a mobile phone in a folded state;

FIG. 2 is a view of fixing and supporting a mobile phone in an unfolded state of a mobile phone support;

FIG. 3 is a view of a mobile phone support in a folded state;

FIG. 4 is a view of a mobile phone support in a non-fully unfolded state;

FIG. 5 is a view of a mobile phone support in a fully unfolded state;

FIG. 6 is an exploded structural view of a mobile phone support; and

FIG. 7 is a three-dimensional structural diagram of a second supporting leg.

### DETAILED DESCRIPTION OF THE EMBODIMENTS

Advantages and features of the present disclosure and methods of implementing the same will be illustrated by the following embodiments described with reference to the drawings. However, the present disclosure may be embodied in different forms and should not be construed as limited to the embodiments set forth herein. Rather, these embodiments are provided to enable the present disclosure to be thorough and complete, and the scope of the embodiments of the present disclosure can be fully conveyed to those skilled in the art. In addition, the present disclosure is limited only by the scope of the claims.

The shapes, dimensions, proportions, angles, and numbers disclosed in the drawings used to describe embodiments of the present disclosure are merely examples, and thus the present disclosure is not limited to the details shown. Like reference numerals refer to like elements throughout this specification. In the following description, when a detailed description of related known functions or configurations is determined to unnecessarily obscure the emphasis of the present disclosure, the detailed description will be omitted. In the case of using "include", "have", and "contain" described in this specification, other components may be added unless "only" is used. Unless indicated to the contrary, terms in the singular may include plural forms.

When an element is interpreted, the element is understood to include an error range although not explicitly described.

In describing a positional relationship, for example, when the positional relationship is described as "on", "above", "below", and "adjacent to", one or more parts may be arranged between two other parts unless "immediately" or "directly" is used.

In describing a time relationship, for example, when a time sequence is described as "after", "then", "next", and "before", unless "just" or "directly" is used, a discontinuous situation may be included.

It should be understood that, although the terms "first", "second", etc. may be used herein to describe various elements, these elements should not be limited by these terms. These terms are only used to distinguish one element from other elements. For example, a first element may be referred to as a second element, and similarly, a second element may be referred to as a first element, without departing from the scope of the present disclosure.

As those skilled in the art may fully appreciate, features of different embodiments of the present disclosure may be partially or fully coupled or combined with each other, and may cooperate with each other in various ways and be driven in technology. Embodiments of the present disclosure may be performed independently of each other, or may be performed together in a mutually dependent relationship.

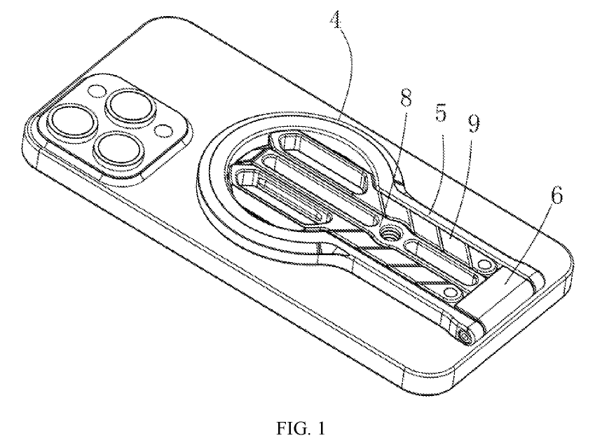

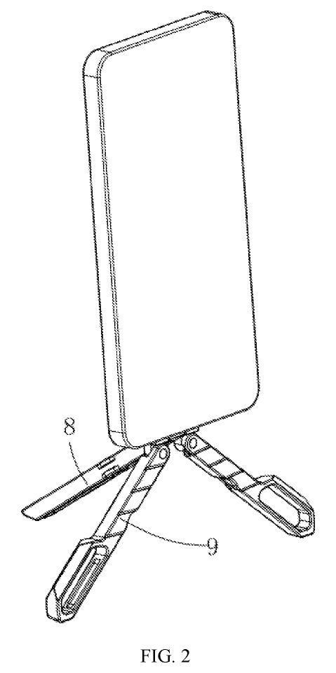

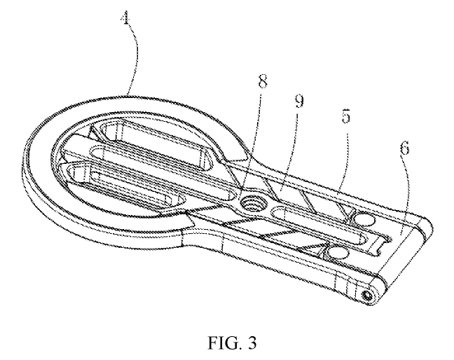

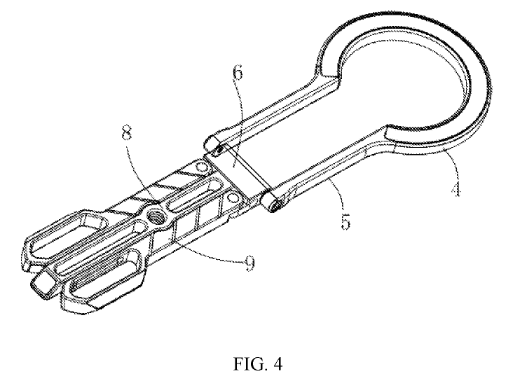

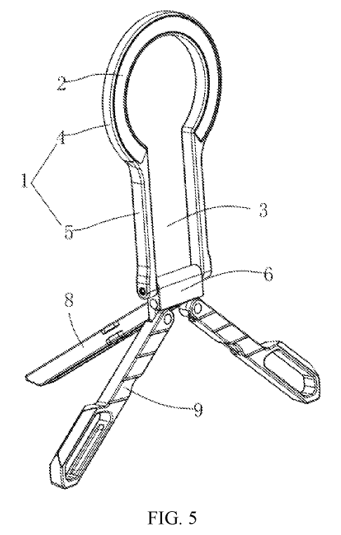

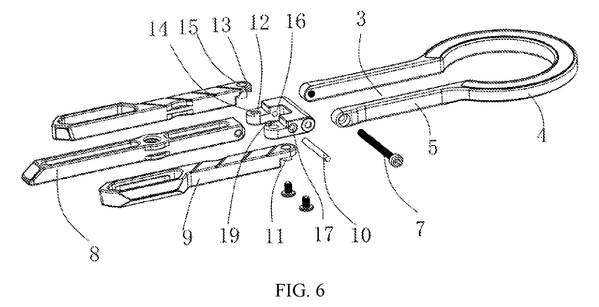

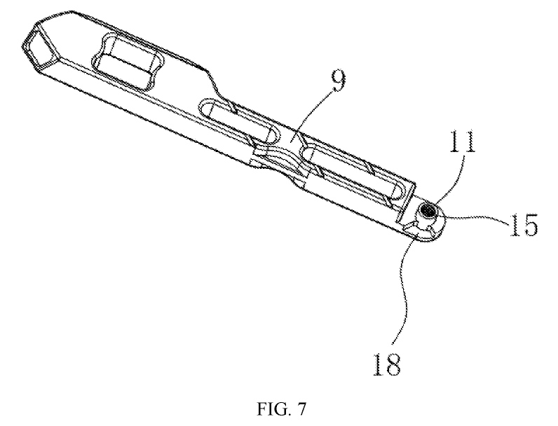

Referring to FIGS. 1 to 7, the present invention discloses a folding ultrathin mobile phone support, including a fixed member 1 and a plurality of supporting legs rotatably connected to the fixed member 1. The fixed member 1 is used for fixing electronic devices such as a mobile phone. In this application, the manner of fixing the mobile phone by the fixed member 1 is preferably magnetic attraction, and therefore, a magnet 2 is arranged in the fixed member 1. When the mobile phone is placed on the fixed member 1, the mobile phone is adsorbed and fixed on the fixed member 1 through magnetic force of the magnet 2, and the mobile phone is conveniently separated from the fixed member 1. The fixed member 1 is provided with a storage groove 3, the supporting legs can be folded into the storage groove 3 by rotation, and the supporting legs located in the storage groove 3 can be unfolded by rotation to form a support. As a result, a thickness of the whole mobile phone support after being folded can be equal to a thickness of the fixed member 1, and an ultrathin effect can be achieved.

As a specific structure, the fixed member 1 includes an annular body 4 and two rod bodies 5, the annular body 4 is provided with two end portions, and the two rod bodies 5 are arranged in parallel and are respectively connected to the corresponding end portion as a whole. Certainly, in this application, the annular body 4 and the two rod bodies 5 are preferably integrally formed by plastic injection molding, such a structure fully embodies a light-weight design. In addition, the space between the rod bodies 5 naturally forms the storage groove 3, which not only saves costs, but also has a light overall weight. The magnet 2 is mounted in the annular body 4. Certainly, an annular groove is formed in the annular body 4, and the magnet 2 can be fixed in the annular groove through glue.

As shown in the figure, a connecting member 6 rotatably connected to the fixed member 1 is further included. The supporting legs are all rotatably connected to the connecting member 6, and the connecting member 6 can be folded into the storage groove 3 by rotation. After the supporting legs are unfolded to support, the fixed member 1 can rotate, so that the inclination angle of the fixed member 1 can be adjusted, and a user can watch the mobile phone more conveniently at a comfortable angle suitable for the himself/herself. A specific structure is as follows: the fixed member 1 includes an annular body 4 and two rod bodies 5, the space between the rod bodies 5 forms the storage groove 3, the connecting member 6 is located between the two rod bodies 5, the connecting member 6 is rotatably connected to the rod body 5 through a connecting shaft 7, the connecting shaft 7 is also a screw, the connecting member 6 is provided with a through hole, the other rod body 5 is provided with a screw hole, the screw penetrates through the through hole to be matched with the screw hole to lock the rod body 5 and the connecting member 6, and the locking force of the screw can be adjusted through the tightness degree of the locking of the screw, so that the friction force between the connecting member 6 and the rod body 5 is adjustable, a proper clamping force is obtained when the fixed member 1 rotates, and the fixed member 1 is kept at a required inclination angle.

As shown in the figure, in this application, three supporting legs include a first supporting leg 8 and second supporting legs 9 oppositely arranged on the connecting member 6, and the first supporting leg 8 and the two second supporting legs 9 form a triangle with a supporting point in contact with a supporting surface after being unfolded. The triangular support is a stable support structure, and is therefore the most preferred structure. Certainly, the number of the supporting legs can also be four or five, or even two or one, and under the condition that the number is less than three, the contact area between the supporting legs and the supporting surface can be increased to achieve support stability.

As shown in the figure, the first supporting leg 8 is rotatably connected to the connecting member 6 through a first rotating shaft 10, and the second supporting legs 9 are both rotatably connected to the connecting member 6 through a second rotating shaft. In order to achieve stable support, the two second rotating shafts 11 are arranged in parallel, and the first rotating shaft 10 is arranged perpendicular to the second rotating shaft 11, in this way, the first supporting leg 8 and the two second supporting legs 9 form an isosceles triangle with a supporting point in contact with a supporting surface after being unfolded, and a center of gravity is located in a middle position of the two second supporting legs 9, thereby achieving force balance.

As shown in the figure, the connecting member 6 is provided with a first connecting plate 12, and the second supporting leg 9 is provided with a second connecting plate 13. The connecting member 6 and the second supporting leg 9 are connected together through the first connecting plate 12 and the second connecting plate 13, so that the overall thickness of the connecting part can be reduced. Furthermore, the first connecting plate 12 is provided with a connecting through hole 14, the second rotating shaft 11 is located on the second connecting plate 13 and inserted into the connecting through hole 14, the second connecting plate 13 is provided with a connecting screw hole 15 penetrating through the second rotating shaft 11, and the screw is matched with the connecting screw hole 15 through the connecting through hole 14. The purpose of the structure is also to adjust a supporting angle of the second supporting leg 9, and the locking force of the screw can be adjusted through the tightness degree of the locking of the screw, so that the friction force between the first connecting plate 12 and the second connecting plate 13 is adjustable, a proper friction force is obtained when the second supporting leg 9 rotates, and the second supporting leg 9 is kept at a required inclination angle. Certainly, as a further structure, the second connecting plate 13 is provided with a limiting groove 18, and the first connecting plate 12 is provided with a limiting block 19 located in the limiting groove 18. The limitation on the rotation angle range of the second supporting leg 9 is achieved through the limiting block 19, so that the user can quickly find the best supporting angle. Certainly, the connecting through hole 14 is preferably a counter bore, so that the head of screw can be hidden, and a rubber ring is preferably arranged in the counter bore, the elasticity of the rubber ring can better reflect the locking force of the screw, so that the friction force between the connecting member 6 and the second supporting leg 9 can be adjusted more finely, and the damping size between the connecting member 6 and the second supporting leg 9 is adjusted more accurately.

As shown in the figure, the connecting member 6 is provided with a groove 16, an end portion of the first supporting leg 8 is located in the groove 16, the connecting shaft 7 is a pin shaft, and the connecting member 6 and the first supporting leg 8 are each provided with a pin hole 17 matched with the pin shaft. The first supporting leg 8 is rotated through a structure in which the pin shaft is matched with the pin hole 17. Decorative pieces are arranged at two ends of the pin shaft and fixed to two ends of the pin hole 17 through glue, which are not only beautiful, but also can prevent the pin shaft from being disengaged.

A folding ultrathin mobile phone support provided by the embodiment of the present invention are introduced in detail above. The principle and implementations of the present invention are described in this specification through specific examples. The descriptions about the embodiments are merely provided to help understand the methods and core ideas of the present invention. In addition, a person of ordinary skill in the art can make variations to the specific implementations and application scopes according to the ideas of the present invention. In summary, the content of this specification shall not be construed as any limitation to the present invention.

What is claimed is:

1. A folding ultrathin mobile phone support, comprising a fixed member and a plurality of supporting legs rotatably connected to the fixed member, wherein the fixed member is provided with a storage groove, the supporting legs can be folded into the storage groove by rotation, and the supporting legs located in the storage groove can be unfolded by rotation to form a support.

2. The folding ultrathin mobile phone support according to claim 1, further comprising a connecting member rotatably connected to the fixed member, wherein the supporting legs are all rotatably connected to the connecting member, and the connecting member can be folded into the storage groove by rotation.

3. The folding ultrathin mobile phone support according to claim 2, wherein the fixed member comprises an annular body and two rod bodies, a space between the rod bodies forms the storage groove, and the connecting member is located between the two rod bodies.

4. The folding ultrathin mobile phone support according to claim 3, wherein the connecting member is rotatably connected to the rod body through a connecting shaft.

5. The folding ultrathin mobile phone support according to claim 2, wherein the plurality of supporting legs comprise a first supporting leg and second supporting legs oppositely arranged on the connecting member, and the first supporting leg and the two second supporting legs form a triangle with a supporting point in contact with a supporting surface after being unfolded.

6. The folding ultrathin mobile phone support according to claim 5, wherein the first supporting leg is rotatably connected to the connecting member through a first rotating shaft, and the second supporting legs are both rotatably connected to the connecting member through a second rotating shaft.

7. The folding ultrathin mobile phone support according to claim 6, wherein the two second rotating shafts are arranged in parallel, and the first rotating shaft is arranged perpendicular to the second rotating shaft.

8. The folding ultrathin mobile phone support according to claim 6, wherein the connecting member is provided with a first connecting plate, the second supporting leg is provided with a second connecting plate, the first connecting plate is provided with a connecting through hole, the second rotating shaft is located on the second connecting plate and inserted into the connecting through hole, the second connecting plate is provided with a connecting screw hole penetrating through the second rotating shaft, the second rotating shaft is a screw, the screw is matched with the connecting screw hole through the connecting through hole, the second connecting plate is provided with a limiting groove, and the first connecting plate is provided with a limiting block located in the limiting groove.

9. The folding ultrathin mobile phone support according to claim 1, wherein a magnet is arranged in the fixed member.

10. The folding ultrathin mobile phone support according to claim 5, wherein a groove is formed in the connecting member, an end portion of the first supporting leg is located in the groove, the connecting shaft is a pin shaft, and the connecting member and the first supporting leg are each provided with a pin hole matched with the pin shaft.
